(19) United States
(12) Patent Application Publication
(10) Pub. No.: US 2001/0034700 A1
(43) Pub. Date: Oct. 25, 2001

(54) Vehicle leasing and customer credit rehabilitation system and method

(76) Inventors: Donald A. Foss, Farmington Hills, MI (US); Keith P. McCluskey, Cincinnati, OH (US); Charles M. Osterman, Brighton, MI (US)

Correspondence Address: Thompson Hine & Flory LLP, 2000 Courthouse Plaza N.E., P.O. Box 8801, Dayton, OH, 45401-8801, US

(21) Appl. No.: 09/789,117

(22) Filed: Feb. 20, 2001

Related U.S. Application Data
(60) Provisional application No. 60/185,944, filed on Feb. 29, 2000.

(51) Int. Cl. G06F 17/60

(52) U.S. Cl. 705/38; 705/39

(57) ABSTRACT

A method for establishing lease agreement terms between a lessee and a lessor prior to entering into a lease agreement between the lessee and the lessor for leasing a vehicle to the lessee includes identifying a plurality of vehicle lease products for a particular lessee, including categorizing each identified vehicle lease product into one of at least two likelihood of lease success classes. At least one of the identified vehicle lease products for further action and an application for the selected vehicle lease product to a lessor. The lessee is rated into one of a plurality of risk categories and a security deposit amount required for the vehicle lease product is established based at least in part upon the lessee rating. Vehicle lease products may be identified and categorized based upon desired vehicle type information, lease term information, and lessee financial information entered into a computer system which includes a vehicle inventory database and software for carrying out such identification and categorization. The lessee rating may be established based upon lessee financial information into a computer system which includes a credit risk database, retrieved lessee credit history information from at least one accessible credit history database. The amount payable from the lessor to the seller is also limited in the subject method.

This application claims the benefit of provisional application Ser. No. 60/185,944 filed Feb. 29, 2000.

### BACKGROUND

The present invention relates generally to methods and systems for leasing vehicles and more particularly to a vehicle leasing and customer credit rehabilitation system.

In the past it has been difficult for persons with extremely poor credit lease vehicles on credit. Obtaining credit for other purposes is also difficult, if not impossible for such persons. Under such circumstances it becomes difficult for such persons to rehabilitate their credit rating.

Further, car dealers often spend significant time negotiating with potential customers only to determine that the customer's financial state or credit history is so poor that conventional lenders will not approve the customer for a loan/lease. If the dealership could convert a small number of these lost sales into actual sales, the income to the dealership could be greatly increased.

Accordingly, it would be desirable to provide a leasing system and method which is directed primarily to persons with poor credit ratings, enables fast approval, and provides persons with the ability to rehabilitate their credit rating.

### SUMMARY

In one aspect, a method for establishing lease agreement terms between a lessee and a lessor prior to entering into a lease agreement between the lessee and the lessor for leasing a vehicle to the lessee includes identifying a plurality of vehicle lease products for a particular lessee, including categorizing each identified vehicle lease product into one of at least two likelihood of lease success classes. At least one of the identified vehicle lease products is selected for further action and an application for the selected vehicle lease product is submitted to a lessor. The lessee is rated into one of a plurality of risk categories and a security deposit amount required for the vehicle lease product is established based at least in part upon the lessee rating. Vehicle lease products may be identified and categorized based upon desired vehicle type information, lease term information, and lessee financial information entered into a computer system which includes a vehicle inventory database and software for carrying out such identification and categorization. The lessee rating may be established based upon lessee financial information into a computer system which includes a credit risk database, retrieved lessee credit history information from at least one accessible credit history database.

In another aspect, a method for leasing a vehicle owned by a seller to a lessee by establishing a lease agreement between the lessee and a lessor includes obtaining lessee information including place of employment and place of residence and requiring the seller to certify to the lessor that the seller has verified the place of employment information and place of residence information. At least one vehicle lease product is selected for the lessee, the vehicle lease product identifying the vehicle to be leased and a plurality of lease terms including vehicle selling price and down payment amount. Information for the selected vehicle lease product is submitted as an application for lease to the lessor, the submitted information including vehicle identification information and lease term information. The lessee is rated into one of a plurality of risk categories and a determination of a lessee security deposit required to establish the lease agreement is made based at least in part upon the lessee rating. The lease agreement is then entered into between the lessee and the lessor, including transferring the lessee security deposit from the lessee to the lessor. A monetary amount is then transferred from the lessor to the seller, the transferred monetary amount being the lower of at least two possible amounts. In one method, the monetary amount transferred to the seller is the lower of: (i) an established wholesale value of the vehicle being leased; or (ii) the vehicle selling price less both (1) a predetermined monetary amount and (2) the down payment amount paid by the lessee to the seller. By limiting the amount payable from the lessor to the lessee in this manner, the seller's incentive to attempt to charge an excessive or outrageous price for the vehicle is controlled.

The above methods may be implemented using a computer based leasing system including a seller computer system including a lease development software engine operable therewith, a vehicle inventory database stored in memory, a display device, and a user interface device; and a lessor computer system including a lease evaluation software engine operable therewith and a risk assessment database stored in memory. A communications link is provided between the seller computer system and the lessor computer system. The lease development software engine includes at least one input module operable to generate at least one lessee information input display screen enabling a user to input lessee identifying information, lessee financial information, lessee desired vehicle information, and lessee desired lease term information. The lease development software engine further includes a lease identification module operable to identify a plurality of vehicle lease products for the lessee by comparing entered lessee desired vehicle information with records within the vehicle inventory database. The lease identification module is further operable to categorize each of the identified vehicle lease products into one of at least two likelihood of lease success classes based at least in part upon entered lessee financial information, and to generate a display of the identified vehicle lease products where each displayed vehicle lease product includes an associated visible display feature which identifies its associated likelihood of success class. The lease development software engine also includes a lease application submission module for electronically transmitting vehicle lease product information and lessee information to the lessor computer system, the transmitted lease product information including at least vehicle identification information, vehicle selling price information, and down payment information, and the transmitted lessee information including at least lessee financial information and lessee identifying information. The lease evaluation software engine includes at least one lessee rating module operable to classify the lessee into one of a plurality of risk categories based at least in part upon comparing lessee financial information to information contained within the risk assessment database, and the lease evaluation software engine is further operable to establish a required lessee security deposit according to the risk category classification made by the lessee rating module, each risk category including an associated, predetermined lessee security deposit amount. A communications link may also be provided from the lessor computer system to a credit tracking company computer system which includes at least one credit history database including credit records for a plurality of individuals, and with the lessee rating module operable to communicate with the credit tracking company computer system to retrieve a credit history record of the lessee from the credit history database before classifying the lessee into a risk category. In this manner the leasing system is fully automated—increasing the speed of lease approval.

All lessees may be approved for credit provided they can pay the required security deposit and provided the lease payment to lessee income ration does not exceed an established threshold level.

### BRIEF DESCRIPTION OF THE DRAWINGS

FIG. 1 is schematic of one embodiment of a computer system for carrying out leasing methods;

FIG. 2 is a schematic of one embodiment of data flow according to the described leasing methods;

FIGS. 3-9 represent various computer screens;

FIG. 10 represents one embodiment of a worksheet or display screen showing the manner in which a monthly lease payment may be established for a given lease;

FIG. 11 represents one embodiment of a worksheet or display screen for establishing the amount of money which the lessor may transfer to the seller upon closing of a given lease, as well as profit to the seller in the event of such lease closing; and

FIG. 12 represents one embodiment of a display screen which enables a seller to evaluate its profitability in the lease system.

### DETAILED DESCRIPTION

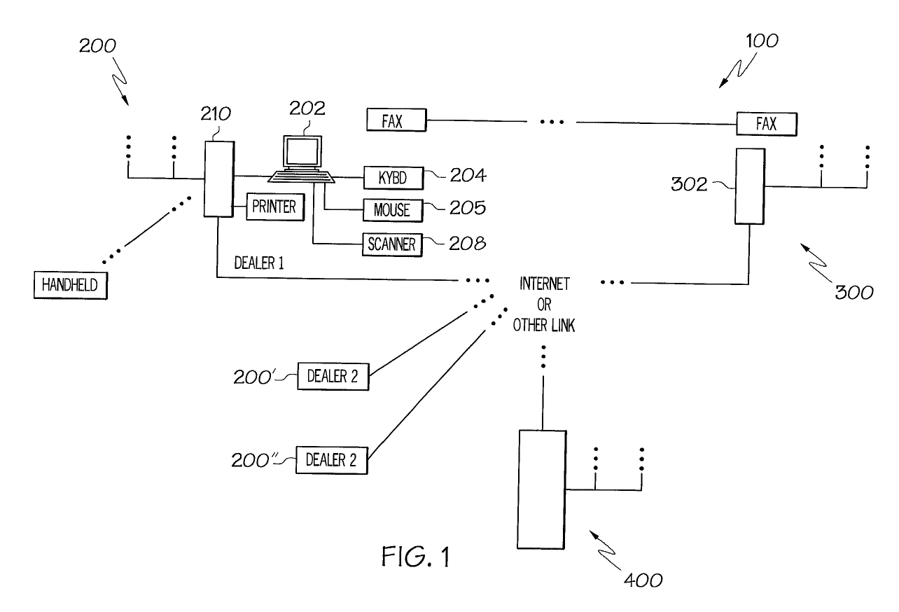

Referring to FIG. 1, an exemplary high-level schematic of a system 100 for use in implementing various leasing methods is depicted and includes at least one dealer/seller computer system 200 and a lessor computer system 300. It is recognized that the leasing methods will most often be utilized by vehicle dealerships in combination with the lessor, however, as used herein the term “seller” refers more broadly to the owner of a vehicle which will be leased by the subject methods, or the a representative of the owner, or any person involved in the leasing process on behalf of the owner. While one dealer/seller computer system 200 is shown in detail, it is recognized that an individual lessor computer system 300 may be connected to multiple dealer/seller computer systems as indicated at 200′ and 200″.

Seller computer system 200 includes at least one user terminal 202 having associated user input devices such as keyboard 204, mouse 206, and scanner 208. The illustrated terminal 202 may be connected to a server 210 which forms a central hub of a larger network as shown. Alternatively, the terminal 202 of the seller computer system 200 may be a stand-alone computer. The seller computer system may also include one or more portable, remote units 212 for car salesman which communicate with the server 210 via RF transmission, or which must be hard-line connected to the server 210 or terminal 202 for communication therewith. The portable, remote unit 212 may provide the salesman with access to inventory information etc. while on the sales lot. The lessor computer system 300 includes at least a server 302 or stand-alone unit, but may be comprised of multiple servers and interconnected computers. A communications link 250 is provided between the seller computer system 200 and the lessor computer system enabling communication therebetween. The communications link 250 may be an internet link or any other type of commonly known communication link. Alternatively, information may be communicated from system 200 to system 300 via fax, where the communicated information is entered into the receiving computer system by a user manually or by scanning. At least one credit bureau or credit tracking company computer system 400 may be provided such that the lessor computer system 300 has automated access thereto for retrieving credit records of individuals therefrom when performing a credit check. Communication link 350 is provided for such automated credit check capability and may be any type of known communication link.

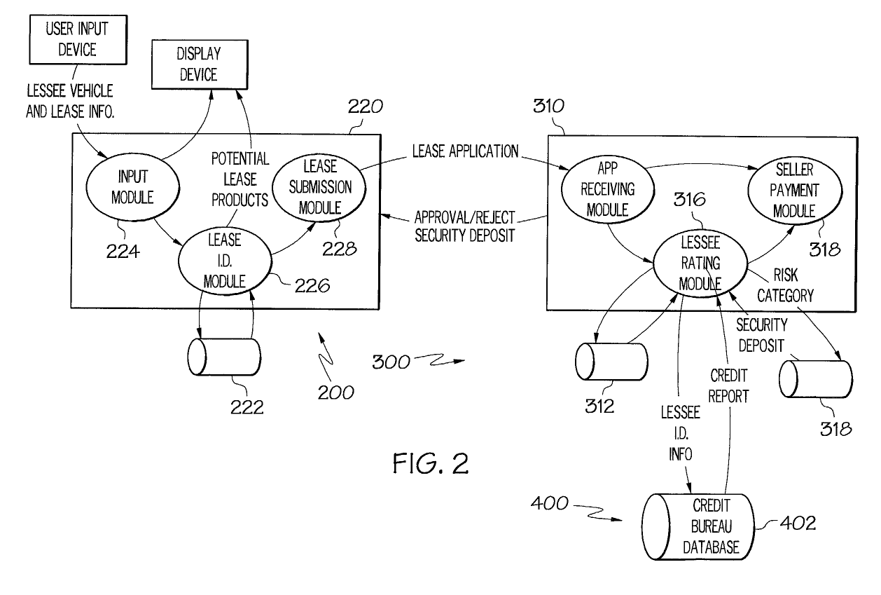

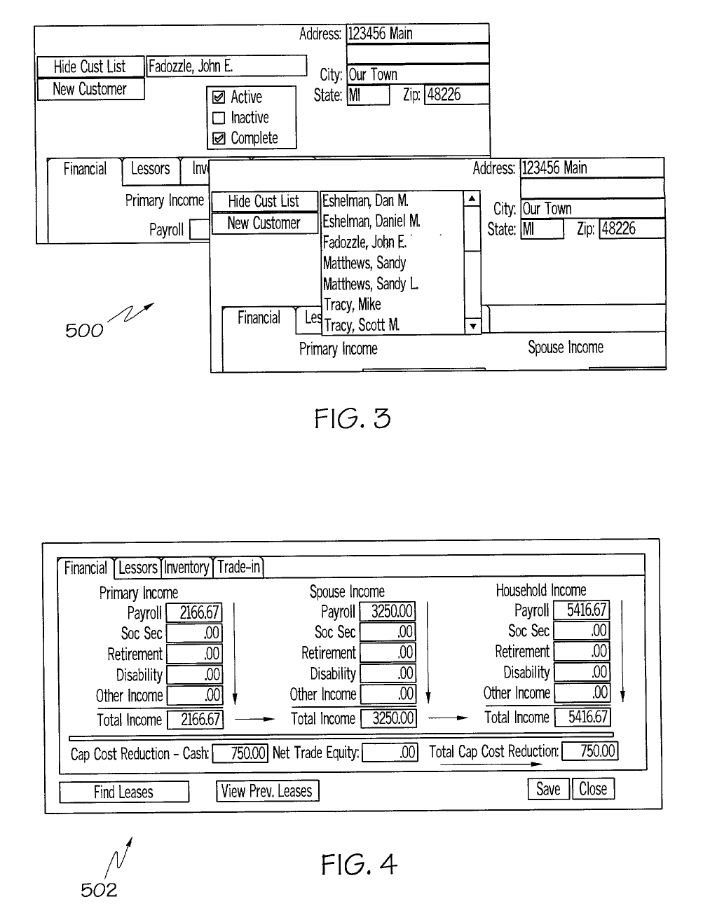

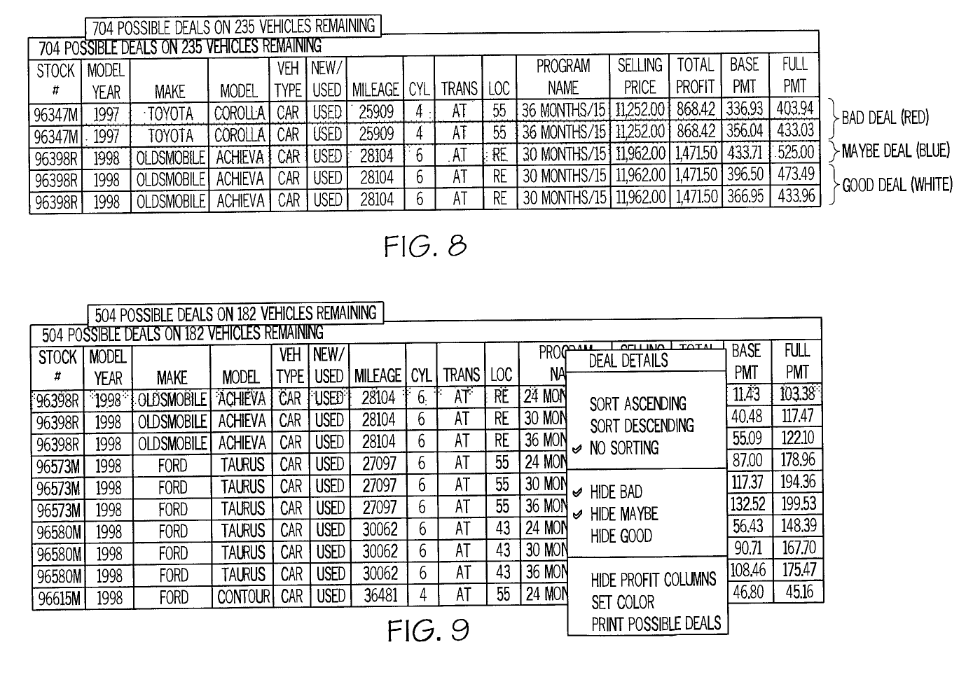

As shown in FIG. 2, the seller computer system 200 includes a lease development software engine 220 operable therewith and a vehicle inventory database 222 stored in memory. The lease development software engine 220 includes at least one input module 224 operable to generate at least one lessee information input display screen (FIGS. 3-7) on a display device enabling a user to input lessee identifying information, lessee financial information, lessee desired vehicle information, and lessee desired lease term information. The information may be entered using any one of the user input devices—including the portable remote terminal. The lease development software engine includes a lease identification module 226 operable to identify a plurality of vehicle lease products for the lessee by comparing entered lessee desired vehicle information with records within the vehicle inventory database. The lease identification module is further operable to categorize each of the identified vehicle lease products into one of at least two likelihood of lease success classes based at least in part upon entered lessee financial information and to generate a display ( FIGS. 8-9) of the identified vehicle lease products on a display device where each displayed vehicle lease product includes an associated visible display feature which identifies its associated likelihood of success class. The identified vehicle lease products may also be printed.

The lease development software engine 220 includes a lease application submission module 228 for electronically transmitting vehicle lease product information and lessee information to the lessor computer system 300, the transmitted lease product information including at least vehicle identification information, vehicle selling price information, and down payment information, and the transmitted lessee information including at least lessee financial information and lessee identifying information. As noted above, such information may alternatively be transmitted via facsimile.

The lessor computer system 300 includes a lease evaluation software engine 310 operable therewith and a risk assessment database 312 stored in memory. The lease evaluation software engine 310 includes an application receiving module 314 and at least one lessee rating module 316 operable to classify the lessee into one of a plurality of risk categories based at least in part upon comparing lessee financial information to information contained within the risk assessment database. The lessee rating module 316 may also operable to communicate with the credit tracking company computer system 400 to retrieve a credit history record of the lessee from the credit history database 402 before classifying the lessee into a risk category. The lease evaluation software engine 410 is further operable to establish a required lessee security deposit according to the risk category classification made by the lessee rating module, each risk category including an associated, predetermined lessee security deposit amount as may be stored in a database 318. The lease evaluation software engine 410 may also be operable to electronically communicate lease approval (including required security deposit information ) to the seller computer system 200. A seller payment module 320 may establish the amount payable to the seller in the event the approved lease is entered into.

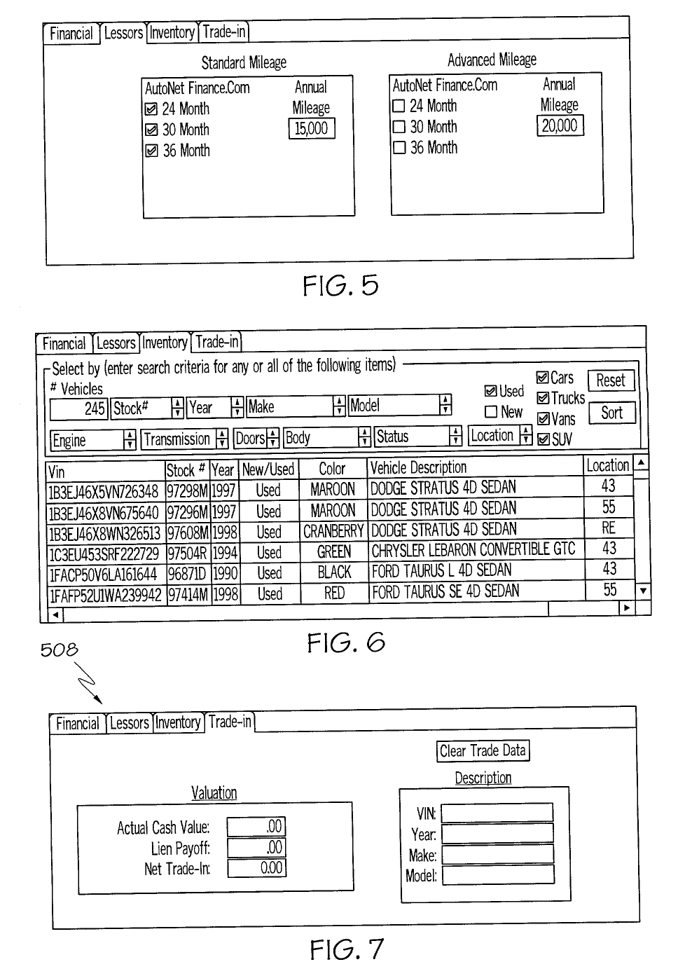

The leasing method of the present invention is now described in greater detail. Referring to FIGS. 3 and 4, exemplary computer generated display screens 502 and 504 for entry of lessee information are shown - such information including name, social security number, address, and income. A salesman may utilize these screens to enter information for a potential customer/lessee or to recall information of a lessee previously entered into the seller computer system. Desired down payment amount (Cap Cost Reduction) and the value of any trade-in vehicle may also be entered. Thus, the total Cap Cost Reduction will typically be the sum of the down payment amount and the trade-in value. The leasing system may be set up with a minimum permitted down payment amount, such as $750, for example. FIG. 5 depicts an exemplary information entry screen 504 which enables a user to enter desired lessee lease terms—such as length of lease and mileage. FIG. 6 depicts an exemplary information entry screen 506 which enables a user to enter lessee desired vehicle information such as year, make and model. FIG. 7 illustrates an exemplary information entry screen 508 for entering trade-in vehicle information.

Utilizing the foregoing screens, desired vehicle type information, desired lease term information into the computer system, and lessee financial information may be entered into the seller computer system. Entered vehicle type information may then be compared with information contained in the vehicle inventory database of the computer system to identify a plurality of potential lease products for the lessee, and each vehicle lease product may be categorized into one of at least two likelihood of success categories based at least in part upon entered lease term information and entered lessee financial information. As depicted in FIG. 8 the vehicle lease products may be displayed in a list according to the likelihood of success category by color-coding each vehicle lease product as RED=bad deal, BLUE=maybe deal, or WHITE=good deal. Other types of categorization identification may also be used. Further, as shown in FIG. 9, the lease identification module 226 may also be selectively operable to enable only certain categories of deals/vehicle lease products to be displayed, enabling a salesman to present to a potential customer/lessee only vehicle lease products which have a reasonable chance of being accepted by the lessor. Various techniques for sorting the identified vehicle lease products may also be provided. A list of vehicle lease products could also be printed for use by a salesmen and/or for presentation to the customer/lessee if desired.

At least one of the identified vehicle lease products may then be selected for further action, and an application for the selected vehicle lease product can be submitted to a lessor. Importantly, the seller is charged with verifying certain lessee information including place of employment and place of residence to reduce the burden on the lessor when considering a lease application. The application for lease may be submitted electronically to the lessor computer system or may be submitted via fax and then entered into the lessor computer system manually or by scanning and OCR. Generally, the application for lease will include lessee identifying information, lessee financial information, vehicle identifying information, selling price information, down payment information, and lease term information such as length and mileage.

The lessor may then retrieve lessee credit history information (credit report) from at least one accessible credit history database, and establish a lessee risk category based at least in part upon comparison of lessee financial information and retrieved lessee credit history information with a credit risk database. The credit risk database is a database of the payment/default history of other poor credit risks. In the preferred embodiment a 1200 point rating scale is used and four risk categories are established, namely platinum, gold silver and bronze. However, it is recognized that other rating scales may be used and less than four or more than four risk categories could be established. Regardless of the risk categorization, some minimum down payment is required for each category. The minimum down payment may be the same for each category or may be different. Further, the risk categorization which is made is used to establish a security deposit which the lessee must deliver to the lessor in order to enter into a lease. Typically the minimum security deposit will increase for less favorable risk categories. For example, the minimum security deposit for a platinum rating may be $500, the minimum security deposit for a gold rating may be $1000, the minimum security deposit for a silver rating may be $1500, and the minimum security deposit for a bronze rating may be $3000. This feature of the leasing method of the present invention may enable the lessor to utilize standard lease terms for all agreements, with only the security deposit amount being varied from customer to customer. Because the seller is required to verify lessee information and because the access to the credit history database of the credit bureau is automated, lease approval can be made in a matter of minutes, improving the ability of a seller to close a deal. The lessor may reserve the right to reverify any lessee information prior to transferring funds to the seller, creating an incentive for the seller to be thorough in its verification of lessee provided information.

The lease agreement may then be entered into between the lessor and the lessee, with title to the vehicle being transferred from the seller to the lessor. The lessor receives the security deposit from the lessee and the seller receives the down payment from the lessee. Importantly, the monetary amount transferred from the lessor to the seller for a given lease agreement may be limited to the lesser of two amounts as shown in FIG. 11. One amount may be an established wholesale value 600 of the vehicle being leased and the other amount may be the vehicle selling price 610 less both (i) a predetermined monetary amount 612 and (ii) the down payment amount 614 paid by the lessee to the seller. The wholesale value for various vehicles may be pre-established by the lessor. Similarly, the predetermined monetary amount may also be pre-established by the lessor and may, in one example, be $1200.

Both the lease development software engine 220 and the lease evaluation software engine 310 may include programming which identifies the amount payable to the seller for a given deal/vehicle lease product. This enables a seller to evaluate the money it will be entitled to receive when the vehicle is leased under certain terms. Importantly, because the amount payable from the lessor to the seller may be limited in the manner described above, the seller's incentive to grossly overprice a vehicle is negated. This advantage is particularly necessary where the target lessees are poor credit risks who are more susceptible to overly aggressive salespersons. Both the lease development software engine 220 and the lease evaluation software engine 310 may also include programming which identifies or calculates the amount of profit to the seller as shown at 620 in FIG. 11.

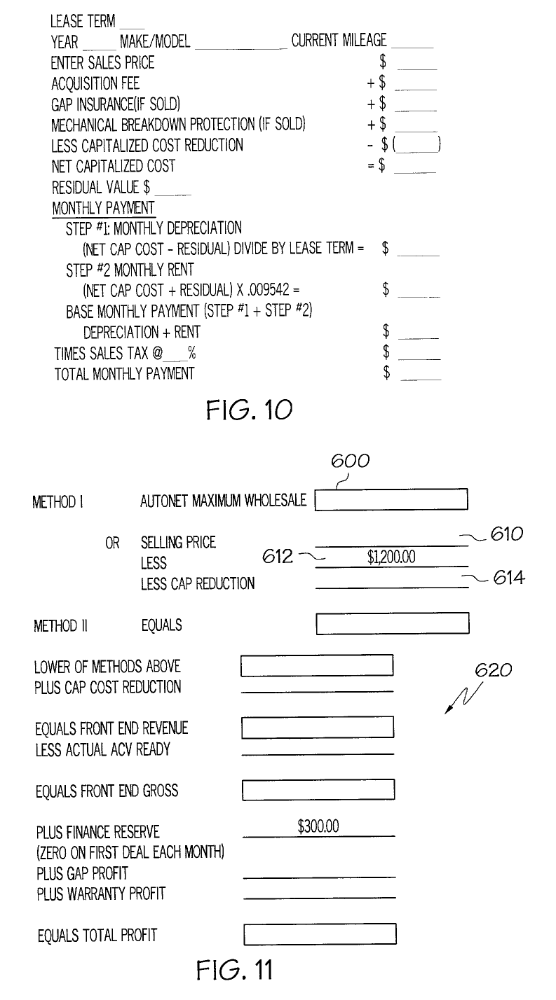

Both the lease development software engine 220 and the lease evaluation software engine 310 may also include programming for determining the monthly lease payment according to the information shown in FIG. 10.

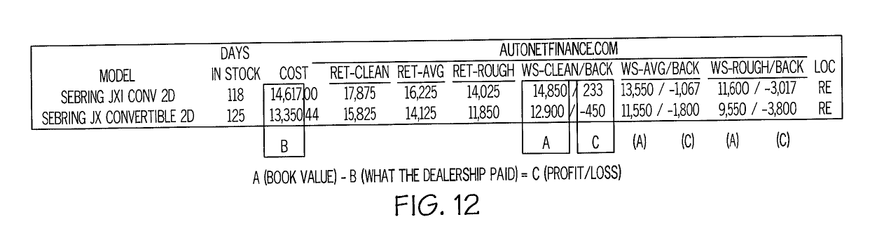

The lease development software engine 220 may also include one or more modules enabling a seller to analyze its success in purchasing used vehicles by comparing the purchase price to the amount receivable if leased according to the above method. In this manner the seller can determine if it is paying too much for used vehicles. Or the seller can utilize the software engine 220 to determine what price to pay for a used vehicle which it intends to offer in the lease program. For example, reference is made to FIG. 12 which shows a screen display 620 which includes the price paid by the seller for a vehicle (B), the wholesale value under the lease program (A) and the profit or loss (C) to the dealer if paid the wholesale price upon lease.

The leasing method and system may also utilize a pre-established maximum allowable monthly payment for a lease product. In one embodiment, this maximum allowable monthly payment does not vary from lessee to lessee, and may be set for example at $525. In this manner, real time approval of lease applications is facilitated. The lease evaluation software engine 310 can automatically reject any submitted lease in which the monthly lease payment exceeds the permitted maximum.

Another aspect of the present leasing system and method is that it provides the lessee the ability to rehabilitate its credit. The lessor computer system may include a lease tracking engine which tracks the status of lease payments for each lease entered into. The tracking engine may automatically communicate payment status information to the credit bureaus on a monthly basis. Further, when a lease is entered into an automated mailing to the lessee may be generated—sending the lessee educational information as to the importance of rehabilitating their credit. If a lease payment is late by a certain time period, another automated mailing (e.g., e-mail, regular mail, phone call) to the lessee may be generated. Further, a credit rehabilitation counselor working for the lessor may automatically be notified and the counselor can contact the lessee to determine if there is a problem and to remind the lessee of the importance of making timely payments.

While the forms of the apparatus herein described constitute preferred embodiments of the invention, it is to be understood that the invention is not limited to these precise forms of apparatus, and changes may be made therein without departing from the scope of the invention. For example, while the illustrated and described embodiments utilize a seller computer system to carry out certain steps and a lessor computer system to carry out other steps, it is possible that a single computer system could carry out all steps, or that the steps might be carried out by the multiple computer systems differently.

What is claimed is:

1. A method for establishing lease agreement terms between a lessee and a lessor prior to entering into a lease agreement between the lessee and the lessor for leasing a vehicle to the lessee, comprising the steps of:
(a) identifying a plurality of vehicle lease products for the lessee, including categorizing each identified vehicle lease product into one of at least two likelihood of lease success classes;
(b) selecting at least one of the identified vehicle lease products for further action;
(c) submitting an application for the selected vehicle lease product to the lessor;
(d) rating the lessee into one of a plurality of risk categories;
(e) establishing a security deposit amount required for the vehicle lease product based at least in part upon the rating made in step (d).

2. The method of claim 1, wherein step (a) includes (i) entering desired vehicle type information into a computer system, and (ii) comparing entered vehicle type information with information contained in a vehicle inventory database of the computer system.

3. The method of claim 2, wherein step (a) further includes (iii) entering lease term information into the computer system, (iv) entering lessee financial information into the computer system, and (v) categorizing each vehicle lease product based at least in part upon entered lease term information and entered lessee financial information.

4. The method of claim 1, wherein step (d) includes (i) entering lessee financial information into a computer system, (ii) retrieving lessee credit history information from at least one accessible credit history database, and (iii) establishing the lessee risk category based at least in part upon comparison of entered lessee financial information and retrieved lessee credit history information with a credit risk database.

5. The method of claim 1 wherein steps (a) and (b) are performed using a seller lease software engine and associated computer system, and wherein steps (d), and (e) are performed using a lessor lease assessment software engine and associated computer system.

6. The method of claim 5 wherein the seller computer system and the lessor computer system are connected via a communications link, and step (c) is performed by electronically submitting application information from the seller computer system to the lessor computer system over the communications link.

7. The method of claim 5 wherein step (e) is performed by reference to a stored table of risk categories and corresponding security deposit amounts.

8. A method for leasing a vehicle owned by a seller to a lessee by establishing a lease agreement between the lessee and a lessor, comprising the steps of:
(a) obtaining lessee information including place of employment and place of residence;
(b) requiring the seller to certify to the lessor that the seller has verified the place of employment information and place of residence information obtained in step (a);
(c) selecting at least one vehicle lease product for the lessee, the vehicle lease product identifying the vehicle to be leased and a plurality of lease terms including vehicle selling price and down payment amount;
(d) submitting information for the selected vehicle lease product as an application for lease to the lessor, the submitted information including vehicle identification information and lease term information;
(e) rating the lessee into one of a plurality of risk categories;
(f) determining a lessee security deposit required to establish the lease agreement based at least in part upon the rating made in step (e);
(g) entering into the lease agreement between the lessee and the lessor, including transferring the lessee security deposit of step (h) from the lessee to the lessor; and
(h) transferring a monetary amount from the lessor to the seller, the transferred monetary amount being the lower of at least two possible amounts.

9. The method of claim 8 wherein in step (h) the monetary amount transferred to the seller is the lower of:
(1) an established wholesale value of the vehicle being leased; or
(2) a vehicle selling price less both (i) a predetermined monetary amount and (ii) the down payment amount paid by the lessee to the seller.

10. The method of claim 9 wherein steps (a) and (c) are performed using a seller lease software engine and associated computer system, and wherein steps (e) and (f) are performed using a lessor lease assessment software engine and associated computer system.

11. The method of claim 10 wherein the seller computer system and the lessor computer system are connected via a communications link, and step (d) is performed by electronically submitting application information from the seller computer system to the lessor computer system over the communications link.

12. The method of claim 8, further comprising the step of:
(i) sending credit rehabilitation information materials to the lessee after step (g).

13. The method of claim 8, further comprising the step of:
(j) tracking a payment status of the lessee; and
(k) if the lessee fails to make a timely payment, sending credit history rehabilitation information materials to the lessee.

14. A computer-implemented method for leasing a vehicle owned by a seller to a lessee, where the lessee has a poor credit history, comprising the steps of:
(a) utilizing a software module which calculates a monetary amount payable from a lessor to the seller upon entry into the lease agreement between the lessee and the lessor and limits such calculated monetary amount to the lesser of:
(i) a maximum wholesale value of the vehicle established by the lessor; or
(ii) the vehicle selling price less both (1) a predetermined monetary amount and (2) a down payment amount to be paid by the lessee to the seller.

15. The method of claim 14, comprising the further steps of:
(b) electronically generating at least one vehicle lease product for the lessee, the vehicle lease product identifying the vehicle to be leased and a plurality of lease terms including vehicle selling price and down payment amount;
(c) electronically submitting information for the selected vehicle lease product as an application for lease to the lessor, the submitted information including vehicle identification information and lease term information;
(d) providing a software module for rating the lessee into one of a plurality of risk categories; and
(e) determining a required lessee security deposit amount for the lease agreement based at least in part upon the rating made in step (d).

16. A computer based leasing system for establishing vehicle lease terms between a lessor and a lessee, a vehicle to be leased being owned by a seller, comprising:
a seller computer system including a lease development software engine operable therewith, a vehicle inventory database stored in memory, a display device, and a user interface device;
wherein the lease development software engine includes at least one input module operable to generate at least one lessee information input display screen enabling a user to input lessee identifying information, lessee financial information, lessee desired vehicle information, and lessee desired lease term information;
wherein the lease development software engine includes a lease identification module operable to identify a plurality of vehicle lease products for the lessee by comparing entered lessee desired vehicle information with records within the vehicle inventory database;
wherein the lease identification module is further operable to categorize each of the identified vehicle lease products into one of at least two likelihood of lease success classes based at least in part upon entered lessee financial information, and to generate a display of the identified vehicle lease products where each displayed vehicle lease product includes an associated visible display feature which identifies its associated likelihood of success class;
a lessor computer system including a lease evaluation software engine operable therewith and a risk assessment database stored in memory;
a communications link between the seller computer system and the lessor computer system;
wherein the lease development software engine includes a lease application submission module for electronically transmitting vehicle lease product information and lessee information to the lessor computer system, the transmitted lease product information including at least vehicle identification information, vehicle selling price information, and down payment information, and the transmitted lessee information including at least lessee financial information and lessee identifying information;
wherein the lease evaluation software engine includes at least one lessee rating module operable to classify the lessee into one of a plurality of risk categories based at least in part upon comparing lessee financial information to information contained within the risk assessment database; and
wherein the lease evaluation software engine is further operable to establish a required lessee security deposit according to the risk category classification made by the lessee rating module, each risk category including an associated, predetermined lessee security deposit amount.

17. The computer based leasing system of claim 16, further comprising:
a communications link from the lessor computer system to a credit tracking company computer system which includes at least one credit history database including credit records for a plurality of individuals; and
wherein the lessee rating module is operable to communicate with the credit tracking company computer system to retrieve a credit history record of the lessee from the credit history database before classifying the lessee into a risk category.

18. The computer based leasing system of claim 16 wherein the lease evaluation software engine is further operable to electronically communicate required security deposit information to the seller computer system.

19. A computer based leasing system for establishing vehicle lease terms between a lessor and a lessee, the vehicle to be leased being owned by a seller, comprising:
a lessor computer system including a lease evaluation software engine operable therewith and a risk assessment database stored in memory;
wherein the lease evaluation software engine includes at least one lessee rating module operable to classify the lessee into one of a plurality of risk categories based at least in part upon comparing lessee financial information to information contained within the risk assessment database; and
wherein the lease evaluation software engine is further operable to establish a required lessee security deposit according to the risk category classification made by the lessee rating module, each risk category including an associated, predetermined lessee security deposit amount.

20. The computer based leasing system of claim 19, further comprising:
a seller computer system including a lease development software engine operable therewith, a vehicle inventory database stored in memory, a display device, and a user interface device;
a communications link between the seller computer system and the lessor computer system;
wherein the lease development software engine includes at least one input module operable to generate at least one lessee information input display screen enabling a user to input at least lessee identifying information, lessee financial information, lessee desired vehicle information, and lessee desired lease term information via the user interface device; and
wherein the lease development software engine includes a lease identification module operable to identify a plurality of vehicle lease products for the lessee by comparing entered lessee desired vehicle information with records within the vehicle inventor database.

21. The computer based leasing system of claim 19:
wherein the lease development software engine includes a lease application submission module for electronically transmitting vehicle lease product information and lessee information to the lessor computer system, the transmitted lease product information including at least vehicle identification information, vehicle selling price information, and down payment information, and the transmitted lessee information including at least lessee income information and lessee identifying information.

22. The computer-based leasing system of claim 19 wherein the lease evaluation software engine includes a lease application receiving module for electronically receiving lease application information.

23. The computer-based leasing system of claim 19 wherein the lease evaluation software engine includes a module which calculates a monetary amount payable from a lessor to the seller upon entry into the lease agreement between the lessee and the lessor and limits such calculated monetary amount to the lesser of:
(i) a maximum wholesale value of the vehicle established by the lessor; or
(ii) a vehicle selling price less both (1) a predetermined monetary amount and (2) a down payment amount to be paid by the lessee to the seller.

24. A computer-based leasing system for establishing vehicle lease terms between a lessor and a lessee, the vehicle to be leased being owned by a seller, comprising:
means for storing a seller vehicle inventory database;
means for inputting lessee identifying information, lessee financial information, lessee desired vehicle information, and lessee desired lease term information;
means for identifying a plurality of vehicle lease products for the lessee by comparing entered lessee desired vehicle information with records within the seller vehicle inventory database;
means for categorizing each of the identified vehicle lease products into one of at least two likelihood of lease success classes based at least in part upon entered lessee financial information;
means for generating a display of the identified vehicle lease products where each displayed vehicle lease product includes an associated visible display feature which identifies its associated likelihood of success class;
means for storing a lessor a risk assessment database;
means for retrieving a lessee credit history report from an accessible credit history database;
means for classifying the lessee into one of a plurality of risk categories based at least in part upon a comparison of both lessee financial information and lessee credit history information to information contained within the lessor risk assessment database; and
means for establishing a required lessee security deposit according to the classified risk category, each risk category including an associated, predetermined lessee security deposit amount.

25. The computer-based leasing system of claim 24, further comprising:
means for tracking lease payments by a lessee, said means including means for automatically generating a credit rehabilitation mailing to the lessee if the lessee fails to make a lease payment in a timely manner.
